(19) United States
(12) Patent Application Publication
(10) Pub. No.: US 2009/0237730 A1
(43) Pub. Date: Sep. 24, 2009

(54) PRINTING CONTROL APPARATUS

(75) Inventors: Shingo TOKUNAGA, Nara (JP); Masaki HIGASHIURA, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/408,115

(22) Filed: Mar. 20, 2009

(30) Foreign Application Priority Data
Mar. 21, 2008 (JP) 2008-073101

(51) Int. Cl. G06F 3/12; G06F 15/00

(52) U.S. Cl. 358/1.15

(57) ABSTRACT

When multiple printing apparatuses which perform tandem printing have been decided, icons of the respective printing apparatuses are displayed on a screen and the number of print copies which has been allocated to each printing apparatus is displayed. A user can see the setting contents at a glance. When the user performs an operation of changing a size of the icons, the display of the number of print copies is changed. Depending on the size of the icons, the number of print copies is changed. In this way, the user does not need to perform operations many times for confirming and setting the tandem printing, and the user can confirm the setting in the tandem printing easily.

### BACKGROUND OF THE INVENTION

1. Field of the Invention

The present invention relates to a printing control apparatus which manages each printing apparatus in a printing system which performs tandem printing in which a print job is allocated to multiple printing apparatuses.

2. Description of the Related Art

In a printing system in which multiple printing apparatuses are connected through a network, tandem printing is performed in which one print job is allocated to the multiple printing apparatuses and the respective printing apparatuses perform printing. The printing apparatuses which execute the tandem printing are selected from printing apparatuses which have been previously registered.

In Japanese Patent Laid-Open No. 2003-223295, in a host computer, when a printing apparatus is selected from a setting screen, a job ticket including print instruction information is generated. Based on this job ticket, a server allocates a print job to respective selected printing apparatuses. The respective printing apparatuses perform printing as instructed, respectively.

Multiple printing apparatuses which perform the tandem printing are managed by a printing control apparatus. In order for a user to confirm the printing apparatuses which are to perform the tandem printing, it is necessary to read such setting information as the above described job ticket from the server and display the setting information on the screen of the printing control apparatus. An operation therefor is required, which is cumbersome for the user. Moreover, if the user hopes to change the printing conditions for the tandem printing, it is necessary to display the setting information on the screen of the printing control apparatus, change the printing conditions, and regenerate the setting information.

In this way, the user has to perform operations many times for confirming and setting the tandem printing, resulting in very poor operability. Consequently, in view of the above description, an object of the present invention is to provide a printing control apparatus which enables the user to easily confirm the setting of the tandem printing.

### SUMMARY OF THE INVENTION

The present invention is a printing control apparatus which is connected to multiple printing apparatuses through a network and manages the respective printing apparatuses which perform tandem printing of a print job, including a display section which displays icons of the multiple printing apparatuses which perform the tandem printing, and a control section which instructs execution of the tandem printing. The display section displays a printing condition which has been set in the respective printing apparatuses when the tandem printing is performed, on the icons. A user can confirm the printing condition in the respective printing apparatuses by seeing the icons.

Specifically, the number of print copies as the print condition is set depending on a size of the icons, and when the size of the icons is changed, the control section changes the number of print copies depending on this change. By performing an operation with respect to the displayed icons, the printing condition can be changed, which reduces effort for an operation of the user considerably.

When the number of print copies of one printing apparatus is changed, the control section changes the number of print copies of other printing apparatuses which perform the tandem printing. If all the number of print copies in one print job is not changed, when the number of print copies of one or more printing apparatuses was changed, the number of printing copies of other printing apparatuses is increased or decreased.

The control section limits the maximum number of print copies for each printing apparatus. Moreover, the control section limits the number of print copies of each printing apparatus in one print job. By limiting the number of print copies depending on a recording sheet stored in the printing apparatus, it is possible to prevent that the recording sheet lacks during printing. The control section generates and outputs a list of the number of print copies which has been set in each printing apparatus.

When the print job is accepted, the display section conspicuously displays icons of printing apparatuses capable of the tandem printing depending on the print job. Depending on the print job, printing apparatuses capable of the printing are decided. When the user hopes to select a printing apparatus, the user can select the printing apparatus easily by seeing display of the icons.

The display section displays a job icon related to the accepted print job, and performs display showing relationship between the print job and printing apparatuses which perform the tandem printing, with respect to the job icon. The display section performs display such that the job icon and an icon of a printing apparatus are connected or surrounded so that both icons are in the same group. It is possible to see the printing apparatuses which perform the tandem printing with respect to the print job at a glance.

When an icon of a printing apparatus which has become unusable is operated, the control section notifies a predetermined communication partner with an available communication system, and the display section displays the operated icon so as to be different from icons of normal printing apparatuses.

When some abnormality occurs in a printing apparatus, the printing apparatus becomes unusable. Since the abnormality is cleared by a serviceman, an operation for notifying to the serviceman is necessary. At this time, by the user's operating the icon, the serviceman can be called automatically.

When the unusable printing apparatus has become usable by the serviceman, the control section recognizes that the printing apparatus is returned into a normal state by the notification from the printing apparatus. The display section returns display of the icon into original display. The user thereby knows that the printing apparatus has become usable.

According to the present invention, when the tandem printing is performed, by seeing the icons displayed on the screen, the set printing condition can be confirmed at once. By performing an operation with respect to the icons, the printing condition can be changed, whereby the user's operation can be simplified and the operability can be improved.

### BRIEF DESCRIPTION OF THE DRAWINGS

FIG. 1 is a diagram showing a schematic configuration of a printing system of the present invention;

FIG. 2 is a diagram showing a management table related to tandem printing;

FIG. 3 is a diagram showing a screen on which printing apparatuses which execute the tandem printing are displayed;

FIG. 4 is a diagram showing a screen on which the number of print copies set in each printing apparatus is displayed;

FIG. 5 is a diagram showing a screen on which a printing apparatus excluded by an operation of a user is displayed;

FIG. 6 is a diagram showing a screen on which a state where the number of print copies is changed is displayed;

FIG. 7 is a diagram showing a screen when an operation of serviceman call is performed for a printing apparatus in which abnormality occurs;

FIG. 8 is a diagram showing a screen when the printing apparatus is returned into a normal state;

FIG. 9 is a diagram showing a screen when an external device is connected;

FIG. 10 is a diagram showing a screen on which printing apparatuses capable of printing image data of the external device are displayed;

FIG. 11 is a diagram showing a screen on which relationship between a print job and printing apparatuses which execute the tandem printing is shown;

FIG. 12 is a flowchart of operations of a printing control apparatus when the tandem printing is performed;

FIG. 13 is a flowchart of the operations of the printing control apparatus when the printing apparatus which performs the tandem printing was excluded; and

FIG. 14 is a flowchart of the operations of the printing control apparatus when the printing apparatus was excluded during the execution of the tandem printing.

### DETAILED DESCRIPTION OF THE PREFERRED EMBODIMENTS

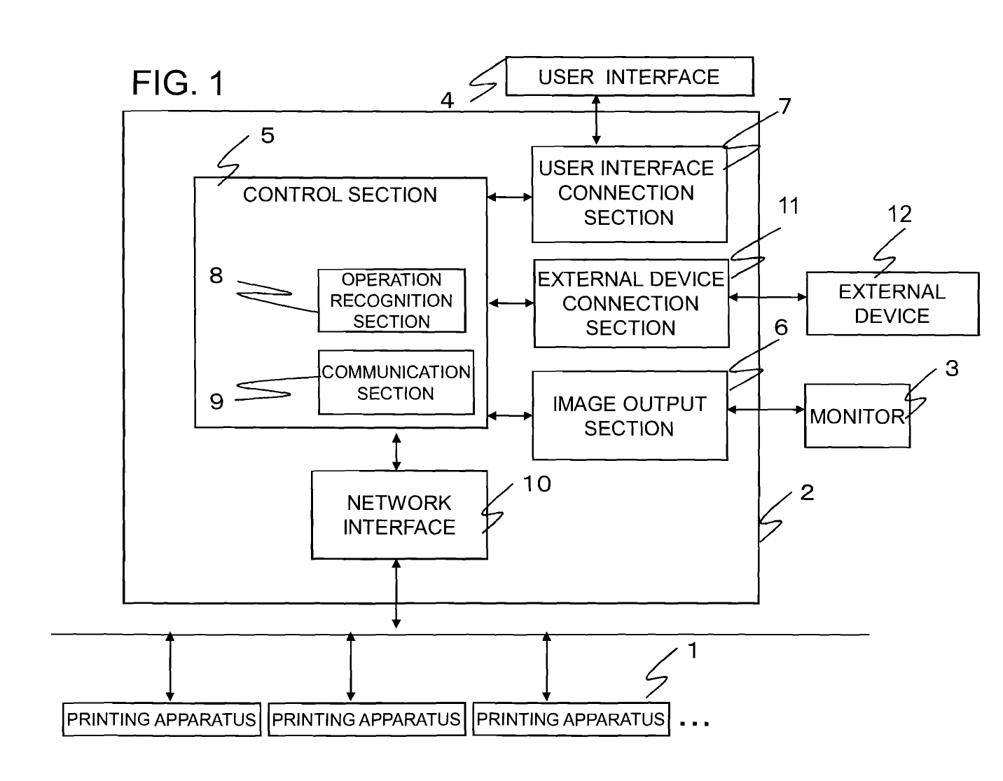

FIG. 1 shows a printing system of this embodiment. The printing system is configured with multiple printing apparatuses 1 and a printing control apparatus 2 which manages the printing apparatuses 1. The respective printing apparatuses 1 and the printing control apparatus 2 are connected so that the respective printing apparatuses 1 and the printing control apparatus 2 can communicate through a network such as a LAN.

The printing apparatus 1 is a printer which prints an image on a recording sheet. It should be noted that the printing apparatus 1 may be a multifunctional peripheral which executes respective processings of copying, printing, scanning, facsimile communication and document filing. The printing apparatus 1 is provided with a communication interface for communicating with the printing control apparatus 2 and other printing apparatuses 1.

When a print job generated by an information processing apparatus such as a personal computer or another printing apparatus 1 is inputted, the printing apparatus 1 prints the image according to instruction information included in the print job. Moreover, the printing apparatus 1 also generates the print job by reading an image from a document.

The printing control apparatus 2 is a common computer, and is provided with a monitor 3 as a display section, a user interface 4 with which an input operation can be performed with respect to an image displayed on a screen of the monitor 3, and a control section 5 which controls the printing in each printing apparatus 1.

The monitor 3 is a liquid crystal display, and is driven by an image output section 6. When the control section 5 outputs image information to the image output section 6, the image output section 6 outputs a driving signal depending on the image information. On the monitor 3, an operation screen or a setting screen is displayed.

The user interface 4 is a touch panel of resistance film type or electromagnetic induction type. The user interface 4 is placed at a front face of the monitor 3. When a user performs an operation with respect to the image displayed on the screen, the user interface 4 generates an operation signal depending on the operation. The user interface 4 is connected to the control section 5 via a user interface connection section 7. In other words, when the user performs the operation with respect to the image such as an icon displayed on the screen of the monitor 3, with a finger or a pen, the user interface 4 detects a touched position, a moving direction, a time and the like and outputs the operation signal. The operation signal is inputted to the control section 5 via the user interface connection section 7.

The control section 5 has an operation recognition section 8 which analyzes contents of the operation from the inputted operation signal, and a communication section 9 for communicating with the printing apparatus 1 through the network. The operation recognition section 8 recognizes operations of the user, such as an operation of inputting characters, pictures or the like, a click operation and a drag operation, based on the operation signal. The control section 5 generates operation information depending on the contents operated by the user.

When the control section 5 outputs the operation information depending on the operation of the user to the printing apparatus 1, the communication section 9 outputs the operation information to a network interface 10. The network interface 10 transmits the operation information to the printing apparatus 1 according to a predetermined communication protocol.

Then, the control section 5 causes the printing apparatus 1 to execute the print job. The print job includes the instruction information such as image data, a printing condition, and output destination information. The print job is inputted from the printing apparatus 1 or the information processing apparatus, or generated in the own apparatus. In other words, when the control section 5 receives the print job, the control section 5 transmits the print job to a printing apparatus 1 specified as an output destination.

Moreover, the printing control apparatus 2 is provided with an external device connection section 11 to which an external device 12 is connected. The external device connection section 11 performs recognition or identification of the external device 12, and performs data transfer between the control section 5 and the external device 12. The external device 12 is a portable storage device including, for example, a USB memory and a hard disc apparatus. Alternatively, the external device 12 may be a communication device incorporated with a mobile phone or a memory such as a PDA. The external device connection section 11 performs wired or wireless communication with the external device 12, reads data stored in the external device 12, and outputs to the control section 5. On the other hand, the data outputted from the control section 5 is written in the external device 12.

In this printing system, the multiple printing apparatuses 1 perform tandem printing. When the tandem printing is executed, the print job is allocated to the multiple printing apparatuses 1. When the printing control apparatus 2 receives the print job, the printing control apparatus 2 instructs the tandem printing directly or indirectly. The divided image data and instruction information are transmitted to the respective printing apparatuses 1, and instruction for the tandem printing is performed. The printing apparatus 1 which has received the instruction prints the image based on the instruction information.

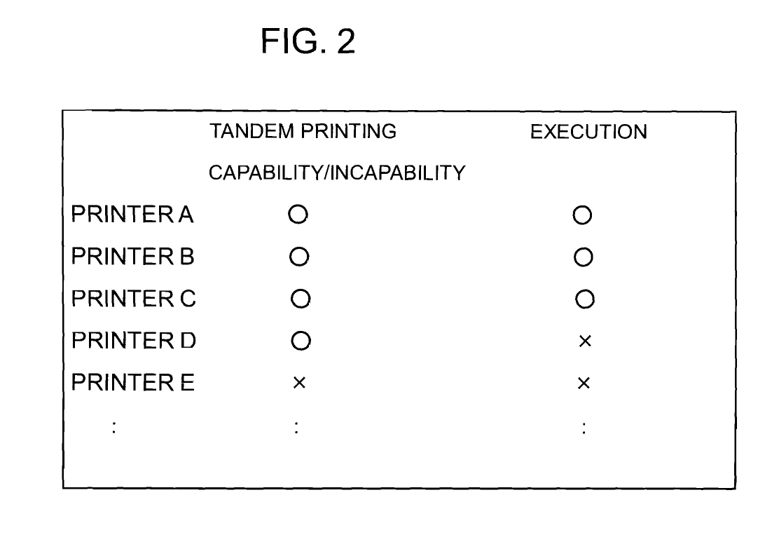

Moreover, the control section 5 generates a management table related to the printing apparatuses 1 belonging to the printing system. The management table is stored in a nonvolatile storage section such as a hard disk apparatus. The management table has attribute information such as performance, an address and an operating status of each printing apparatus 1. The attribute information also includes information on the tandem printing for each printing apparatus 1, as shown in FIG. 2. In other words, the information is able/disable information showing whether or not the printing apparatus 1 is capable of the tandem printing, and execution information showing whether or not the printing apparatus 1 is executing the tandem printing. The printing apparatus 1 capable of the tandem printing has been previously set, and the control section 5 generates the able/disable information depending on this setting and registers the able/disable information in the management table. Moreover, the control section 5 identifies the printing apparatuses 1 which execute the tandem printing, based on the instruction information, and generates the execution information.

Here, one printing apparatus 1 is set as a parent machine from the multiple printing apparatuses 1. Other printing apparatuses 1 become child machines. When the tandem printing is performed, the printing control apparatus 2 receives the print job and performs the instruction for the tandem printing through the parent machine. In other words, the printing control apparatus 2 instructs the tandem printing indirectly.

The printing control apparatus 2 transmits the print job to the parent machine and requests the tandem printing. When the parent machine receives the request of the tandem printing, the parent machine distributes the print job to the multiple child machines based on the instruction information, with reference to the attribute information of the multiple printing apparatuses 1, and instructs the respective child machines to perform the printing. The printing control apparatus 2 registers the printing apparatus 1 which is the parent machine, in the management table, and in addition, the printing control apparatus 2 acquires information of the child machines which perform the tandem printing from the parent machine, generates the execution information, and registers the execution information in the management table.

It should be noted that, if the parent machine has not been set, the printing control apparatus 2 functions as the parent machine, and performs the instruction directly. In other words, the printing control apparatus 2 allocates the print job to the multiple printing apparatuses 1 and performs the instruction for the printing.

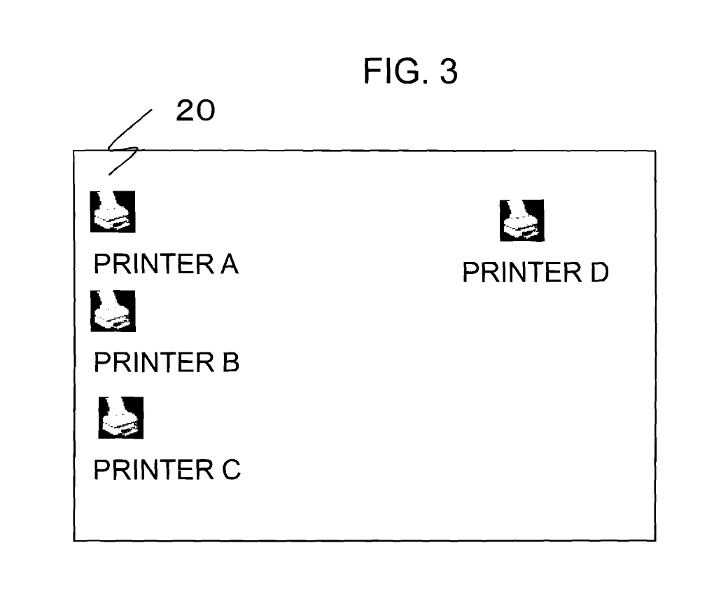

In the printing control apparatus 2, in order to intend to improve user operability when the tandem printing is performed, as shown in FIG. 3, the printing apparatuses 1 which have become targets for the tandem printing are displayed on the screen of the monitor 3. With reference to the management table, the control section 5 specifies the printing apparatuses 1 which perform the tandem printing, and instructs the image output section 6 to display appropriate printing apparatuses 1. The image output section 6 outputs the driving signal for displaying icons 20 for the printing apparatuses 1, to the monitor 3. On the screen of the monitor 3, the icons 20 of the multiple printing apparatuses 1 are displayed. In other words, on the screen, the icons 20 of all of the printing apparatuses 1 capable of the tandem printing are displayed. The icon 20 of the printing apparatus 1 incapable of the tandem printing is not displayed on the screen. The user can confirm the printing apparatuses 1 capable of the tandem printing, at a glance.

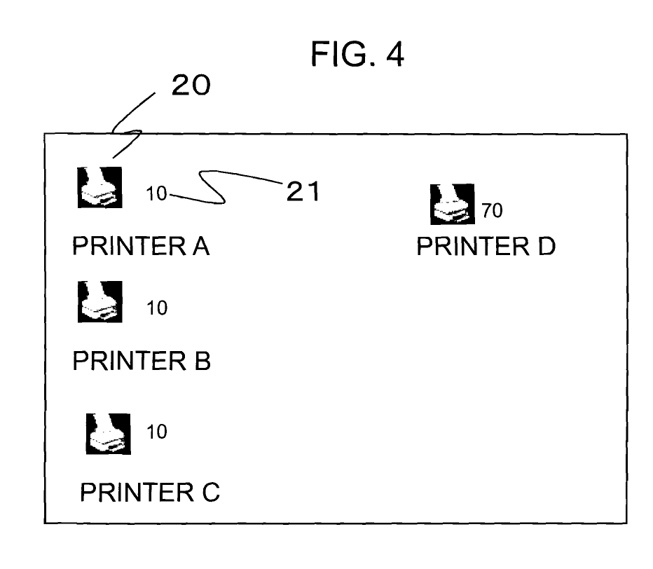

Here, the control section 5 causes detailed set information of the tandem printing to be displayed. The set execution information includes a printing condition such as the number of print copies allocated to the multiple printing apparatuses 1 which perform the tandem printing. The control section 5 causes the icons 20 to display the set printing condition for the tandem printing. As shown in FIG. 4, on the screen of the monitor 3, the icons 20 of the respective printing apparatuses 1 as well as icons 21 of the number of print copies are displayed as the printing condition. It should be noted that, in addition to the number of the print copies, printing conditions such as a sheet size, color/monochrome, single side/double side, and N up may be displayed. The user can visually confirm what kind of printing is performed in the respective printing apparatuses 1.

The maximum number of print copies can be set for each of the printing apparatuses 1 which perform the tandem printing. When the user inputs the maximum number of print copies, the control section 5 registers the maximum number of print copies in the attribute information. Depending on the maximum number of print copies, the parent machine or the printing control apparatus 2 decides the number of print copies of the respective printing apparatuses 1 within the limits of the maximum number of print copies.

It should be noted that the maximum number of print copies may be automatically decided by the parent machine or the printing control apparatus 2. Depending on an amount of the recording sheet stored in the printing apparatus 1, the maximum number of print copies is decided. On the screen, the maximum number of print copies is displayed. By limiting the number of print copies in this way, it is possible to prevent that the recording sheet lacks during printing and to execute the printing smoothly.

Moreover, in the print job, all the number of print copies is decided. Depending on the maximum number of print copies set in each printing apparatus 1, the number of print copies of each printing apparatus 1 in the print job is restricted. In other words, in proportion to the maximum number of print copies of each printing apparatus 1, the number of print copies is distributed for each printing apparatus 1. By setting the number of print copies in this way, it is possible to prevent the printing from being concentrated on one printing apparatus 1. Printing according to the status of each printing apparatus 1 is performed so that the tandem printing can be executed efficiently.

The printing control apparatus 2 generates a list of the number of print copies of each printing apparatus 1 set as described above. The control section 5 generates the list and performs output in a desired form. As the output form, for example, the list is displayed on the screen, the printing apparatus 1 is caused to print the list, the list is transmitted to an information processing apparatus such as a personal computer through a network, or the list is outputted to the external device 12 to be stored. The user can confirm setting in the tandem printing easily. It should be noted that the list may include not only the number of print copies but also other execution information such as the maximum number of print copies.

Moreover, when the user has performed the operation with respect to the icon 20 of the printing apparatus 1 displayed on the screen, the control section 5 sets or alters the instruction information in the print job, based on the input of the operation signal from the user interface 4 depending on the operation of the user.

Thereby, the user can select the printing apparatuses 1 which perform the tandem printing. In other words, when the user has performed an operation of excluding the icon 20 of the printing apparatus 1 on the screen, the control section 5 excludes the above described printing apparatus 1 from the targets of the tandem printing. At this time, the control section 5 alters the execution information on the excluded printing apparatus 1 in the management table. Then, the control section 5 displays the screen so that the icon 20 of the excluded printing apparatus 1 and the icons 20 of the printing apparatuses 1 which execute the tandem printing are different from each other.

As an operation when the user excludes the printing apparatus 1, the user draws a mark such as “x” on the icon 20 on the screen. The control section 5 identifies the marked printing apparatus 1 based on the operation signal from the user interface 4, and excludes the above described printing apparatus 1. Then, a mark is displayed on the icon 20 on the screen. It should be noted that, instead of displaying the mark, a color of the icon 20 may be changed so that the icon 20 can be distinguished from other icons 20.

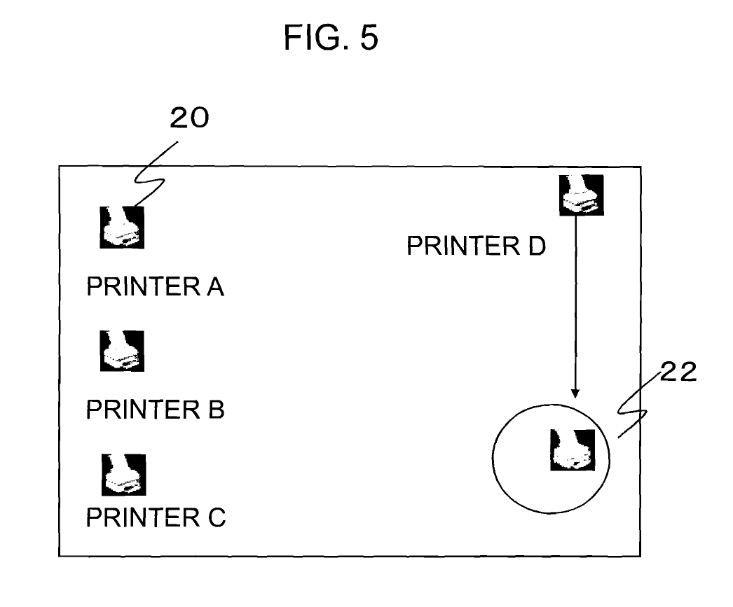

Moreover, as shown in FIG. 5, when an icon of a trash box 22 has been displayed on the screen, the user performs an operation of dragging the icon 20 and putting the icon 20 in the trash box 22. Based on the operation signal from the user interface 4, the control section 5 excludes the printing apparatus 1 corresponding to the icon 20 put in the trash box 22. Then, the icon 20 being dragged is displayed, and eventually the icon 20 is displayed within the trash box 22.

The user drags the icon 20 on the screen so that the icon 20 is put out of the screen. The control section 5 excludes the printing apparatus 1 corresponding to the operated icon 20. Then, the icon 20 of the above described printing apparatus 1 is displayed in the trash box 22.

When the user performs an operation of selecting the multiple icons 20, these icons 20 are grouped. Then, if the user performs an operation of excluding this group, such as dragging this group to the trash box 22, the user can collectively exclude the multiple printing apparatuses 1.

It should be noted that, if an operation of returning the icon 20 to its original state was performed with respect to the icon 20 of the excluded printing apparatus 1, the control section 5 sets the above described printing apparatus 1 as the printing apparatus 1 which executes the tandem printing. Then, the display of the icon 20 on the screen is also returned to its original display.

When the user has performed an operation of touching the icon 20 displayed on the screen, the user interface 4 generates the operation signal depending on this operation. In response to this operation signal, the control section 5 controls the image output section 6 to display the attribute information on the printing apparatus 1 corresponding to the touched icon 20. On the screen, an attribute screen representing the attribute information on the printing apparatus 1 is displayed. Thereby, the user can confirm whether or not the printing apparatus 1 is appropriate for executing the tandem printing. Then, when the user decides the printing apparatus 1 to be excluded, the user can select an appropriate printing apparatus 1 using this attribute information.

Moreover, when the user has performed an operation of inputting characters or numbers on the icon 20 on the screen, the control section 5 recognizes contents of the input and sets the instruction information in the print job. The user performs an operation of drawing the characters or the numbers which have been previously registered, on the icon 20. The user interface 4 generates the operation signal depending on this operation. Based on this operation signal, the control section 5 recognizes the specified printing apparatus 1, also recognizes the inputted characters or numbers, and sets the printing condition in the above described printing apparatus 1. Then, the control section 5 generates the instruction information according to the set printing condition. It should be noted that, if the inputted printing condition has been already set, the inputted printing condition is set again.

For example, when numbers are inputted, the number of print copies is set. When “double side” is inputted, double-sided printing is set. When “2up” is inputted, a printing condition of aggregating two pages into one page is set. Thereby, the printing condition depending on an object of the user can be set, which can improve the user operability.

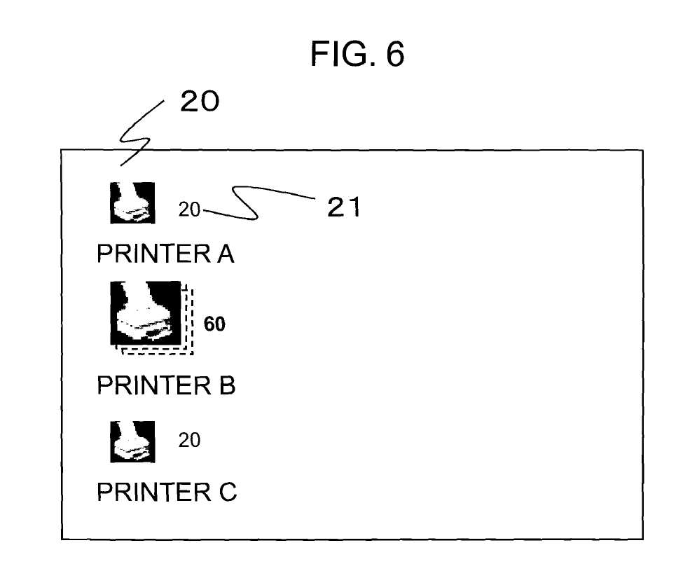

Instead of inputting the numbers directly in such a way as described above, when the user has performed the operation of altering the icon 20 of the printing apparatus 1, the printing condition is changed. A size of the icon 20 is set depending on the number of print copies. As the size of the icon 20 becomes larger, the number of print copies is increased. When the size of the icon 20 is changed, the control section 5 changes the number of print copies depending on this change. As shown in FIG. 6, when the user has performed an operation of increasing the size of the icon 20, the display is made so that the number of print copies is gradually increased. The user performs an operation with respect to the icon 20 while viewing the display of the number of print copies. When desired number of print copies is reached, the user stops the operation. On the screen, the changed number of print copies is displayed.

Here, when all the number of print copies is not changed, the control section 5 reduces the number of print copies of other printing apparatuses 1 depending on the increased number of print copies. Then, the changed number of print copies of each printing apparatus 1 is displayed.

Based on the printing condition such as the changed number of print copies, the control section 5 performs the instruction to the respective printing apparatuses 1. When the parent machine has been set, the control section 5 notifies the change to the parent machine. The parent machine instructs the child machines to change the number of print copies.

The printing control apparatus 2 manages the operating status of the multiple printing apparatuses 1. When abnormality such as a failure, maintenance, and replenishment of consumable materials occurs, the printing apparatus 1 becomes unusable. When such an abnormality occurs, the abnormality is notified from the printing apparatus 1 to the printing control apparatus 2. The control section 5 causes the icon 20 of the printing apparatus 1 in which the abnormality occurs to display the abnormality. The user sees the icon 20 displayed differently from the icons 20 of other printing apparatuses 1 to recognize that the printing apparatus 1 is unusable.

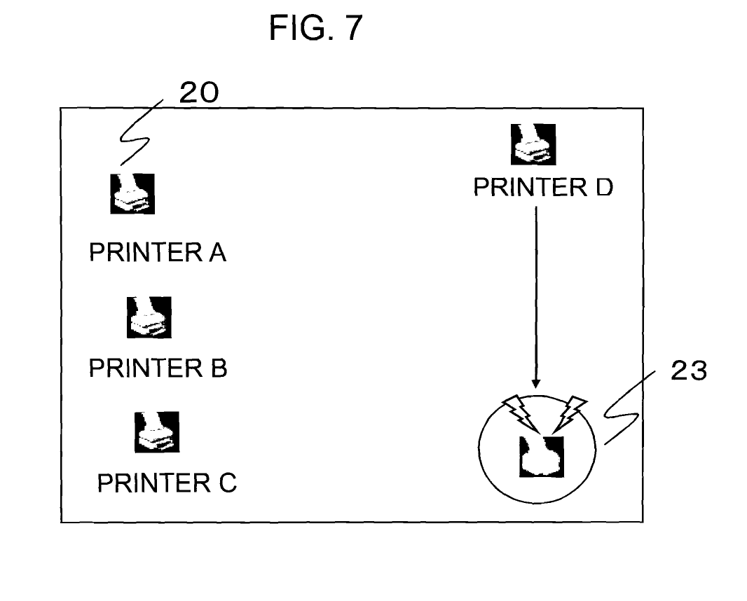

As shown in FIG. 7, the control section 5 causes the screen to display a specific region 23 for serviceman call. The specific region 23 may be displayed by a graphic only with a frame, or an icon. The specific region 23 is preferably displayed when the abnormality of the printing apparatus 1 is notified.

When the user has performed an operation of dragging the icon 20 of the printing apparatus 1 and putting it in the specific region 23, the control section 5 recognizes this operation and requests a communication destination which has been previously specified to clear the abnormality. A communication system at this time is selected depending on a connection environment of the network. The control section 5 transmits the request to a mail address of a serviceman, for example, with an electronic mail. A request message is transmitted to a management server of an owner of the printing apparatus 1 using a communication protocol such as HTTP. Moreover, by facsimile communication such as internet FAX, the request message is transmitted to a specified facsimile apparatus or an image processing apparatus.

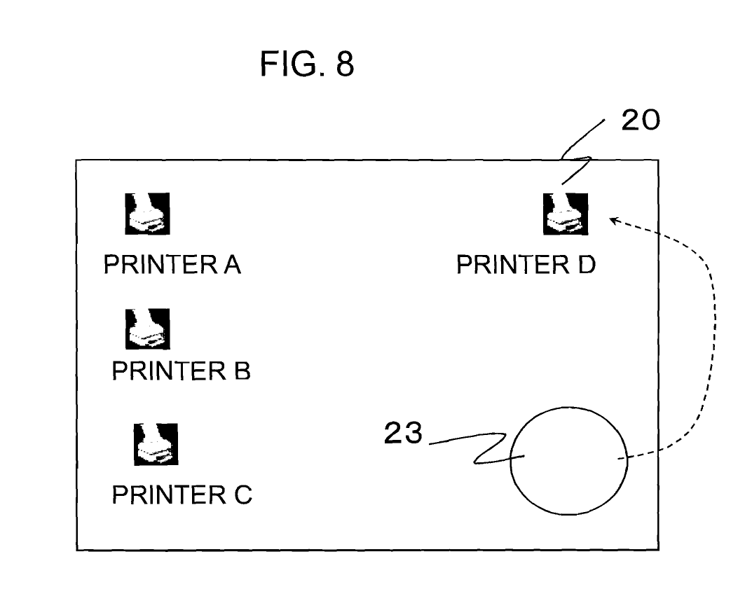

The serviceman who has received the request clears the abnormality of the printing apparatus 1. When the printing apparatus 1 becomes usable, the printing apparatus 1 notifies the printing control apparatus 2 that the printing apparatus 1 has returned to normal. The control section 5 of the printing control apparatus 2 returns the display of the icon 20 of the printing apparatus 1 to the original display. As shown in FIG. 8, the icon 20 displayed within the specific region 23 is displayed at an original position. Thus, the user can easily confirm that the printing apparatus 1 is returned to a usable state.

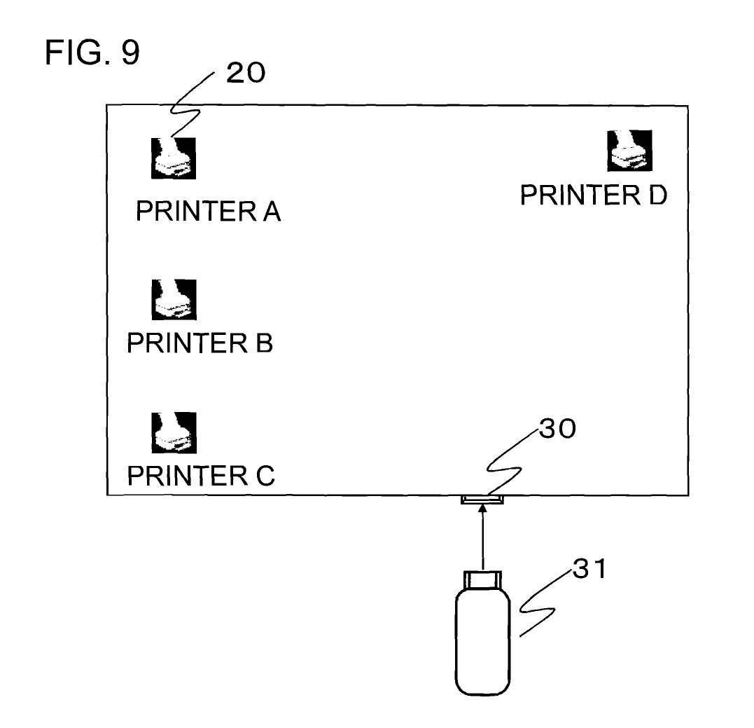

In this printing control apparatus 2, the print job can be inputted using the external device 12. When the external device 12 is connected to the external device connection section 11, the control section 5 detects this connection by a detection signal from the external device connection section 11. At this time, the control section 5 causes the screen to display an image that the external device is being connected. As shown in FIG. 9, an image that an image 31 of the external device 12 is put in an image 30 of the connection section 11 is displayed. As a result, the user can recognize that the external device 12 is being connected.

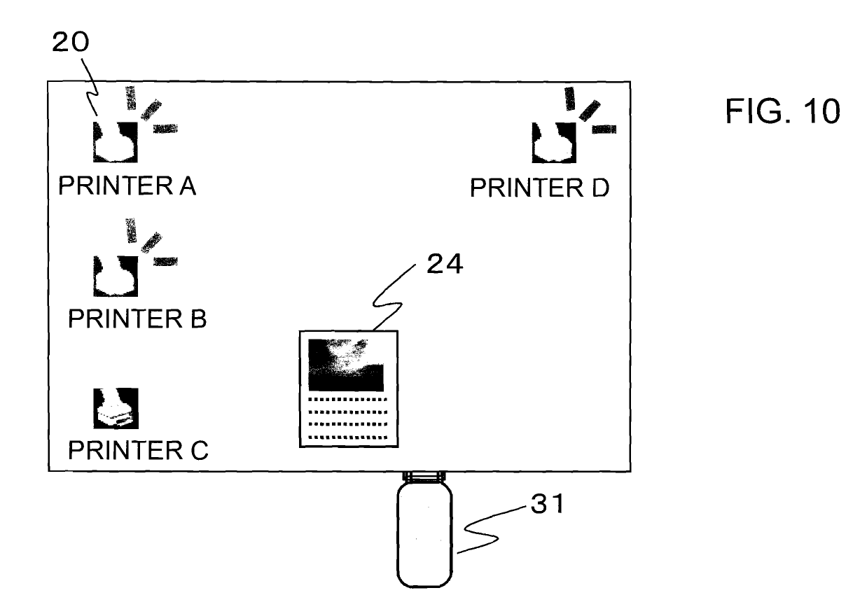

The user selects a file among files stored in the external device 12, inputs the printing condition and the like, and instructs the printing. The control section 5 reads the file from the external device 12, and generates the print job. Then, the control section 5 causes a job icon 24 related to the print job to be displayed. As shown in FIG. 10, the job icon 24 is displayed on the screen. Here, on the job icon 24, image data to be printed is displayed as a thumbnail image. The user can confirm the image to be printed.

Moreover, the control section 5 displays the icons 20 of the printing apparatuses 1 capable of printing the print job conspicuously. The control section 5 selects the printing apparatus 1 capable of the printing depending on the instruction information in the print job. For example, when color printing is performed, the printing apparatus 1 which is capable of color printing is selected. The icon 20 of the selected printing apparatus 1 is displayed so as to be blinked. When the user selects the printing apparatus 1, the user can distinguish the printing apparatus 1 capable of the printing easily.

Moreover, when the user changes the printing condition, for example, to monochrome printing, the control section 5 selects the printing apparatus 1 capable of the printing depending on this change. Then, the control section 5 causes the icon 20 to be displayed conspicuously.

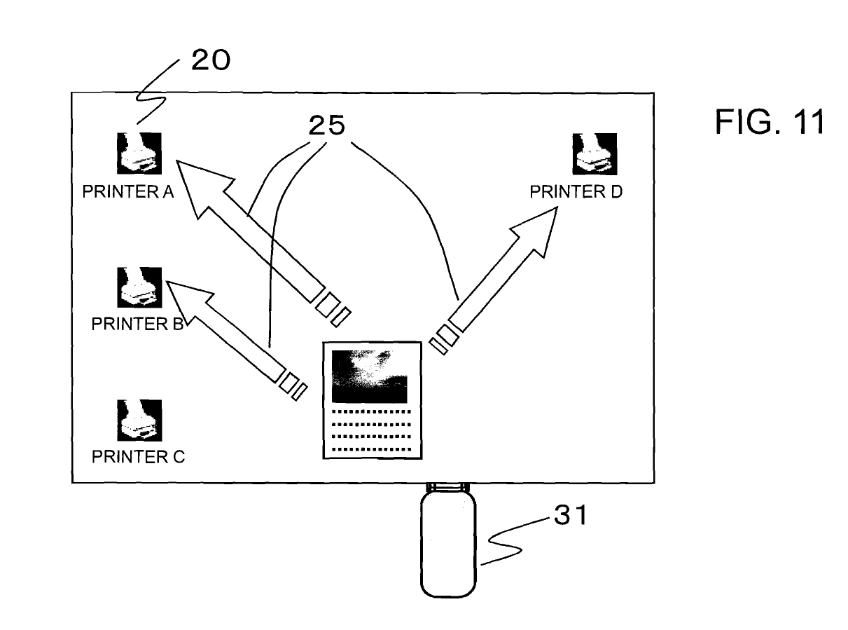

When the user inputs the instruction to start the printing, the control section 5 instructs the printing. At this time, the control section 5 makes a display so that relationship between the print job and the printing apparatus 1 which executes the tandem printing is shown. As shown in FIG. 11, an arrow 25 is displayed from the job icon 24 toward the icon 20 of the printing apparatus 1. The user can confirm the printing apparatus 1 which is executing the tandem printing clearly.

Moreover, when the user moves the arrow 25 to connect the icon 20 of the different printing apparatus 1 and the job icon 24, the control section 5 recognizes that the printing apparatus 1 has been changed and instructs the change in the printing condition.

When there are multiple print jobs, the job icons 24 are displayed for each of the print jobs. Depending on the print jobs, the printing apparatus 1 which performs the tandem printing is different. For each job icon 24, the arrow connecting the icon 20 of the related printing apparatus 1 is displayed.

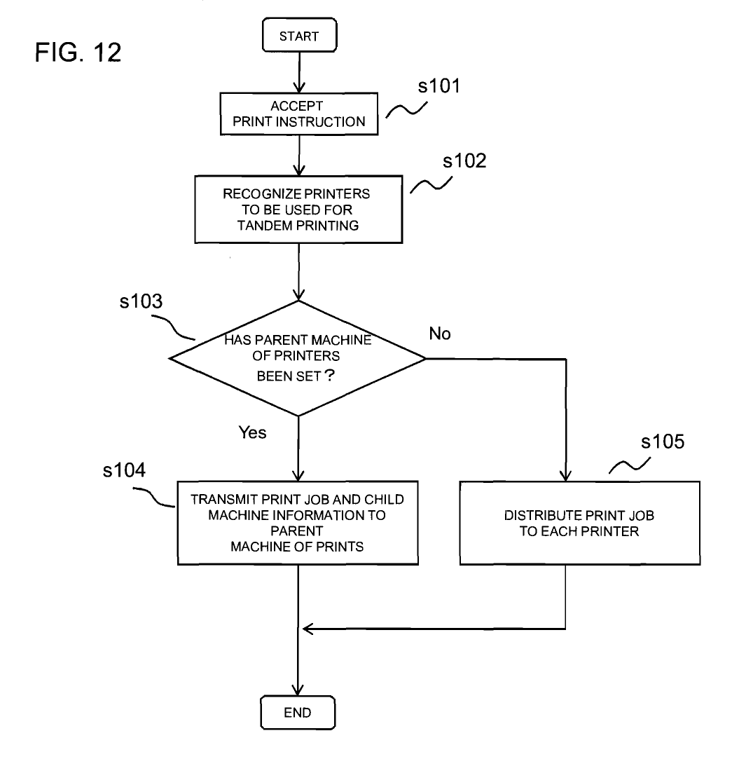

Next, operations of the printing control apparatus 2 when the tandem printing is performed will be described. As shown in FIG. 12, the printing control apparatus 2 accepts the print instruction when the print job is inputted from outside (S101). The control section 5 recognizes that the instruction is for the tandem printing, from the instruction information in the print job, and searches the printing apparatus 1 capable of the tandem printing based on the able/disable information in the management table. Then, the control section 5 controls the display output section 6 to display all of the printing apparatuses 1 capable of the tandem printing. As shown in FIG. 3, the icons 20 of the multiple printing apparatuses 1 are displayed on the screen (S102). The displayed printing apparatuses 1 can execute the tandem printing.

The control section 5 confirms whether or not the parent machine has been set (S103). If the parent machine has been set, the control section 5 transmits the print job and child machine information to the parent machine (S104). The child machine information is generated based on the execution information in the management table.

When the parent machine receives the print job, the parent machine divides the print job for each printing apparatus 1 which is the child machine, including the own apparatus, based on the instruction information and the child machine information, and transmits the print job to each printing apparatus 1. As shown in FIG. 4, on the screen, the number of print copies is displayed with respect to the icons 20 of the printing apparatuses 1 which has been instructed to perform the tandem printing. The respective printing apparatuses 1 including the parent machine print the image as instructed, respectively.

If the parent machine has not been set, the control section 5 divides the print job for each printing apparatus 1, and transmits the print job to each printing apparatus 1 (S105). The respective printing apparatuses 1 print the image as instructed, respectively.

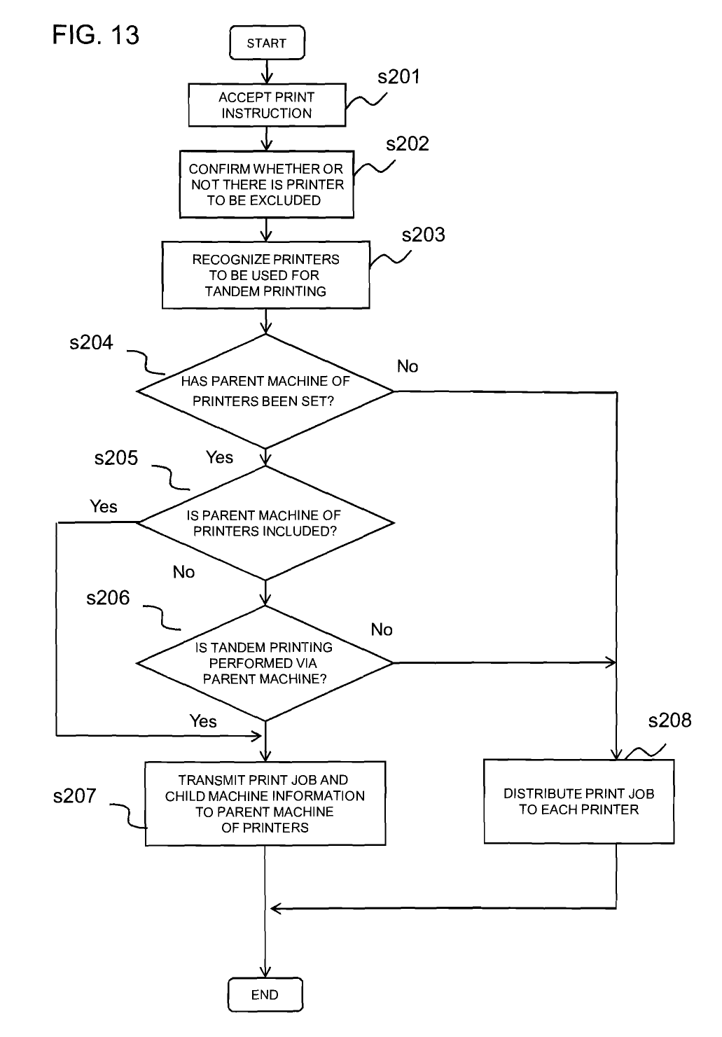

Incidentally, the user can select the printing apparatuses 1 which perform the tandem printing. In this case, as shown in FIG. 13, when the printing control apparatus 2 receives the print instruction (S201), the control section 5 causes the printing apparatuses 1 which execute the tandem printing to be displayed based on the execution information. The user performs the operation of excluding one or more icons 20 from the icons 20 of the multiple printing apparatuses 1 displayed on the screen. The user interface 4 outputs the operation signal depending on this operation to the control section.

When the operation signal from the user interface 4 is inputted, the control section 5 confirms that the operation of excluding the printing apparatus 1 has been performed (S202). Then, the control section 5 identifies the excluded printing apparatus 1 based on the operation signal, and recognizes the printing apparatuses 1 which execute the tandem printing (S203). At this time, the execution information in the management table is rewritten. Moreover, on the screen, the icon 20 of the excluded printing apparatus 1 is displayed in a form different from the icon 20 of the printing apparatus 1 which executes the tandem printing.

The control section 5 confirms whether or not the parent machine has been set, based on the management table (S203). If the parent machine has been set, the control section 5 determines whether or not the parent machine is included in the printing apparatuses 1 which execute the tandem printing, based on the execution information (S205). When the parent machine executes the tandem printing, the control section 5 transmits the print job and the child machine information to the parent machine (S207).

When the parent machine receives the print job, the parent machine divides the print job for each printing apparatus 1 including the own apparatus, based on the instruction information and the child machine information, and transmits the print job to each printing apparatus 1. The respective printing apparatuses 1 including the parent machine print the image as instructed, respectively.

If the parent machine has been excluded, the parent machine does not execute the tandem printing. At this time, the control section 5 determines whether or not to perform the tandem printing via the parent machine (S206). If the parent machine has been set, whether or not the printing control apparatus 2 is substituted for the parent machine has been previously set.

If the parent machine is not included in the printing apparatuses 1 which execute the tandem printing, when the printing control apparatus 2 was set not to be substituted for the parent machine, the control section 5 transmits the print job and the child machine information to the parent machine (S207). When the parent machine receives the print job, the parent machine divides the print job for each printing apparatus 1, based on the instruction information and the child machine information, and transmits the print job to each printing apparatus 1. The respective printing apparatuses 1 print the image as instructed, respectively.

If the parent machine has not been set, or if the parent machine has been set, but the parent machine is excluded and the printing control apparatus 2 is substituted for the parent machine, the control section 5 divides the print job for each printing apparatus 1, and transmits the print job to each printing apparatus 1 (S208). The respective printing apparatuses 1 print the image as instructed, respectively.

In the above description, before the tandem printing is started, the user selects the printing apparatuses 1 which execute the tandem printing. During the execution of the tandem printing, the printing apparatus 1 can also be changed. In other words, during the execution of the tandem printing, the icons 20 of the printing apparatuses 1 executing the tandem printing are displayed on the screen of the monitor 3. The user performs the operation of excluding the icon 20 of the printing apparatus 1.

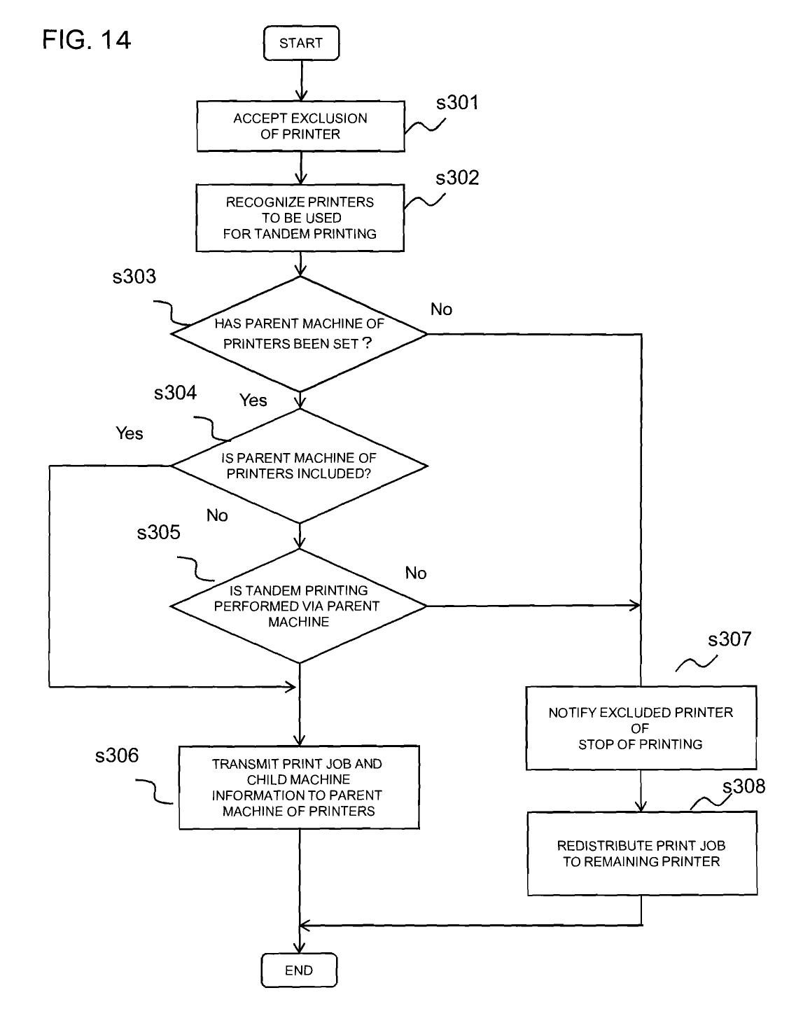

As shown in FIG. 14, the control section 5 accepts the exclusion of the printing apparatus 1 through the operation signal from the user interface 4 (S301). Then, the control section 5 recognizes that the printing apparatus 1 executing the tandem printing has been excluded. Operations at S302 and subsequent steps are the same as the operations at S203 and subsequent steps shown in FIG. 13.

However, since the printing apparatus 1 executing the tandem printing has been excluded, another printing apparatus 1 performs substitute printing. Instruction for the substitute printing is performed by the parent machine or the printing control apparatus 2. If the parent machine has been set, the instruction for the substitute printing is performed by the parent machine. If the parent machine has not been set, or if the parent machine has been set, but the parent machine is excluded and the printing control apparatus 2 is substituted for the parent machine, the instruction for the substitute printing is performed by the printing control apparatus 2.

In the substitute printing, the parent machine or the control section 5 of the printing control apparatus 2 notifies the excluded printing apparatus 1 of stop of the printing (S307). Then, the print job allocated to the excluded printing apparatus 1 is redistributed to another printing apparatus 1 (S308). It should be noted that one or more other printing apparatuses 1 are selected from the remaining printing apparatuses 1 which execute the tandem printing. The excluded printing apparatus 1 stops the printing. Another printing apparatus 1 which has received the instruction prints the image according to the redistributed print job.

When the printing apparatus 1 is excluded or the printing condition is changed during the execution of the tandem printing, the parent machine or the printing control apparatus 2 changes the number of print copies of each printing apparatus 1. The control section 5 acquires the changed printing condition and causes the changed number of print copies to be displayed.

As described above, since the printing apparatuses 1 corresponding to the icons 20 displayed on the screen execute the tandem printing, the user can know the status of the tandem printing by seeing the screen. Moreover, by displaying the print condition such as the number of print copies on the screen, the user can utilize this display when the printing apparatus 1 is changed or excluded. Accordingly, it is not necessary to perform an operation for the display and it is possible to intend to improve user operability. In addition, since the setting of the print condition can be easily performed on the screen, the setting for the tandem printing can be performed easily and convenience for the user can be improved.

It should be noted that the present invention is not limited to the above described embodiment, and of course, it is possible to add many modifications and alterations to the above described embodiment within the range of the present invention. The printing control apparatus may be a printing apparatus having a user interface. As the user interface, a cursor may be displayed on the screen of the monitor and a pointing device such as a mouse for operating the cursor may be used.

The icon may have a form depending on the printing condition. For example, in the case of a size of a recording sheet, the icon is displayed in the form of the recording sheet. The size of the icon is decided depending on the size of the recording sheet. In the case of single side/double side, the icon in which a front face of the recording sheet can be viewed or the icon in which the front face and the rear face can be viewed is displayed. In the case of color/monochrome, the colored icon or the monochrome icon is displayed. In the case of N up, the icon in which one page is divided into N pieces is displayed. Moreover, when the user performs an operation of changing the forms of these icons, the control section changes the printing condition depending on the change in the icons.

What is claimed is:

1. A printing control apparatus which is connected to multiple printing apparatuses through a network and manages the respective printing apparatuses which perform tandem printing of a print job, the printing control apparatus comprising:
a display section which displays icons of the multiple printing apparatuses which perform the tandem printing; and
a control section which instructs execution of the tandem printing,
wherein the display section displays on the icons a printing condition which has been set in the respective printing apparatuses when the tandem printing is performed.

2. The printing control apparatus according to claim 1, wherein the number of print copies as the printing condition is set depending on a size of the icons, and when the size of the icons was changed, the control section changes the number of print copies depending on the change.

3. The printing control apparatus according to claim 2, wherein when the number of print copies of one printing apparatus was changed, the control section changes the number of print copies with respect to other printing apparatuses which perform the tandem printing.

4. The printing control apparatus according to claim 1, wherein when the print job was accepted, the display section conspicuously displays icons of printing apparatuses capable of the tandem printing depending on the print job.

5. The printing control apparatus according to claim 1, wherein the display section displays a job icon related to the accepted print job, and performs display showing the relationship between the print job and the printing apparatuses which perform the tandem printing with respect to the job icon.

6. The printing control apparatus according to claim 1, wherein when an icon of a printing apparatus which has become unusable was operated, the control section notifies a predetermined communication partner with an available communication system, and the display section displays the operated icon so as to be different from icons of normal printing apparatuses.

7. The printing control apparatus according to claim 6, wherein when the unusable printing apparatus has become usable, the display section returns display of the icon into original display.

8. The printing control apparatus according to claim 1, wherein the control section limits the maximum number of print copies for each printing apparatus.

9. The printing control apparatus according to claim 1, wherein the control section limits the number of print copies of each printing apparatus in one print job.

10. The printing control apparatus according to claim 9, wherein the control section generates and outputs a list of the number of print copies which has been set in each printing apparatus.
